(19) United States
(12) Patent Application Publication
(10) Pub. No.: US 2018/0286548 A1
(43) Pub. Date: Oct. 4, 2018

(54) SOFT MAGNETIC POWDER, POWDER MAGNETIC CORE, MAGNETIC ELEMENT, AND ELECTRONIC DEVICE

(71) Applicant: Seiko Epson Corporation, Tokyo (JP)

(72) Inventor: Atsushi NAKAMURA, Hachinohe (JP)

(21) Appl. No.: 15/936,846

(22) Filed: Mar. 27, 2018

(30) Foreign Application Priority Data
Mar. 28, 2017 (JP) 2017-062969

(51) Int. Cl. H01F 1/20; H01F 27/255; H01F 27/28

(52) U.S. Cl. CPC H01F 1/20; H01F 27/2823; H01F 27/255

(57) ABSTRACT

A soft magnetic powder has a metal particle which contains an Fe—Al-M-based alloy wherein M is at least one of Cr and Ti, and a surface layer which is provided on the surface of the metal particle and contains alumina as a main material. The surface layer contains an oxide of the M at a content amount lower than that of alumina. Further, the Fe is contained as a main component, the Al is contained at 0.5 mass % or more and 8 mass % or less, and the M is contained at 0.5 mass % or more and 13 mass % or less.

### BACKGROUND

### 1. Technical Field

The present invention relates to a soft magnetic powder, a powder magnetic core, a magnetic element, and an electronic device.

### 2. Related Art

Recently, the reduction in the size and weight of mobile devices such as notebook-type personal computers has advanced. However, in order to achieve both a reduction in size and an enhancement of performance at the same time, it is necessary to increase the frequency of a switching power supply. At present, the driving frequency of a switching power supply has been increased to several hundred kilo hertz or more. However, accompanying this increase, a magnetic element such as a choke coil or an inductor which is built in a mobile device also needs to be adapted to cope with the increase in the frequency.

For example, JP-A-2012-238828 discloses a magnetic material composed of a particle molded body which includes a plurality of metal particles composed of an Fe—Si-M-based soft magnetic alloy wherein M is a metal element which is more easily oxidized than Fe, and an oxidized coating film formed on the surface of each metal particle, and has a binding portion formed on the surfaces of the metal particles adjacent to each other through the oxidized coating film and a binding portion of the metal particles in a portion where the oxidized coating film is not present. JP-A-2012-238828 attempts to improve the insulation resistance and magnetic permeability at the same time by using such a magnetic material. By improving insulation resistance, the eddy current loss is reduced, and therefore, the iron loss of the magnetic core at a high frequency can be suppressed. Further, by improving magnetic permeability, the magnetic core can be miniaturized.

However, the magnetic metal particles described in JP-A-2012-238828 have a problem in moldability when producing a particle molded body by powder compaction molding. That is, the flowability of the magnetic metal particles in a shaping mold is low, and therefore, the filling ratio is decreased, and as a result, it is difficult to sufficiently increase the magnetic permeability.

### SUMMARY

An advantage of some aspects of the invention is to provide a soft magnetic powder which has excellent moldability and an excellent insulating property between particles, a powder magnetic core and a magnetic element, each of which includes the soft magnetic powder, and an electronic device which includes the magnetic element.

The advantage can be achieved by the following configurations.

A soft magnetic powder according to an aspect of the invention has a metal particle which contains an Fe—Al-M-based alloy wherein M is at least one of Cr and Ti, and a surface layer which is provided on the surface of the metal particle and contains alumina as a main material.

According to this configuration, a soft magnetic powder which has excellent moldability and an excellent insulating property between particles is obtained.

In the soft magnetic powder according to the aspect of the invention, it is preferred that the surface layer contains an oxide of the M at a content amount lower than that of the alumina.

According to this configuration, while sufficiently ensuring the insulating property derived mainly from alumina, stabilization of the alumina in the surface layer can be achieved by the addition of chromium oxide or titanium oxide.

In the soft magnetic powder according to the aspect of the invention, it is preferred that Fe is contained as a main component, the Al is contained at 0.5 mass % or more and 8 mass % or less, and the M is contained at 0.5 mass % or more and 13 mass % or less.

According to this configuration, a soft magnetic powder which is rich in magnetism and has favorable mechanical properties is obtained. Further, a favorable balance between the improvement of the magnetic permeability and the improvement of the volume resistivity of the soft magnetic particle can be achieved. Further, sufficient stabilization of the alumina in the surface layer is achieved.

In the soft magnetic powder according to the aspect of the invention, it is preferred that the mass ratio of the Al to the M is 0.5 or more and 6 or less.

According to this configuration, the adhesion between the metal particle and the surface layer and the stabilization of the alumina in the surface layer can be achieved at the same time.

A powder magnetic core according to an aspect of the invention includes the soft magnetic powder according to the aspect of the invention.

According to this configuration, a powder magnetic core which has a high insulating property between particles derived from the soft magnetic powder and a high magnetic permeability derived from a high filling property is obtained.

A magnetic element according to an aspect of the invention includes the powder magnetic core according to the aspect of the invention.

According to this configuration, a magnetic element which has high reliability is obtained.

An electronic device according to an aspect of the invention includes the magnetic element according to the aspect of the invention.

According to this configuration, an electronic device which has high reliability is obtained.

### BRIEF DESCRIPTION OF THE DRAWINGS

Embodiments of the invention will be described with reference to the accompanying drawings, wherein like numbers reference like elements.

FIG. 1 is a cross-sectional view showing one particle of an embodiment of a soft magnetic powder according to the invention.

FIG. 2 is a schematic view (plan view) showing a choke coil, to which a first embodiment of a magnetic element according to the invention is applied.

FIG. 3 is a schematic view (transparent perspective view) showing a choke coil, to which a second embodiment of a magnetic element according to the invention is applied.

FIG. 4 is a perspective view showing a structure of a mobile-type (or notebook-type) personal computer, to which an electronic device including a magnetic element according to an embodiment is applied.

FIG. 5 is a plan view showing a structure of a smartphone, to which an electronic device including a magnetic element according to an embodiment is applied.

FIG. 6 is a perspective view showing a structure of a digital still camera, to which an electronic device including a magnetic element according to an embodiment is applied.

### DESCRIPTION OF EXEMPLARY EMBODIMENTS

Hereinafter, a soft magnetic powder, a powder magnetic core, a magnetic element, and an electronic device according to the invention will be described in detail based on preferred embodiments shown in the accompanying drawings.

### Soft Magnetic Powder

The soft magnetic powder according to this embodiment is a metal powder having soft magnetism. Such a soft magnetic powder can be applied to any purpose for which soft magnetism is desired to be utilized, and is used, for example, for producing a powder magnetic core by molding the powder into a given shape.

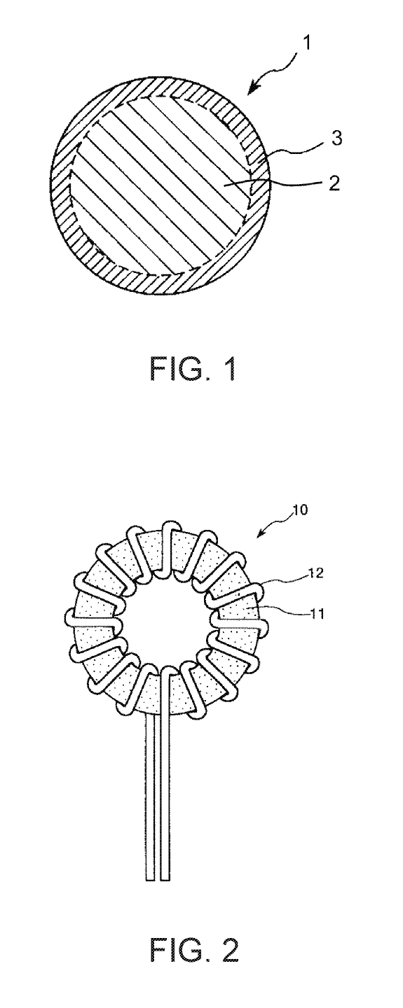

FIG. 1 is a cross-sectional view showing one particle of the embodiment of the soft magnetic powder according to the invention. In the following description, for the convenience of explanation, one particle of the soft magnetic powder is referred to as “soft magnetic particle,” and the “soft magnetic powder” refers to a material including an aggregate of a plurality of soft magnetic particles.

The soft magnetic particle 1 shown in FIG. 1 has a metal particle 2 which contains an Fe—Al-M-based alloy wherein M is at least one of Cr and Ti, and a surface layer 3 which is provided on the surface of the metal particle 2. The surface layer 3 contains alumina as a main material.

Such a soft magnetic particle 1 has excellent moldability and an excellent insulating property between particles by the alloy composition of the metal particle 2 and by providing the surface layer 3. Therefore, the soft magnetic powder is filled at a high filling ratio, and also in this case, a high insulating property between the soft magnetic particles 1 is ensured, and therefore, as a result, a powder magnetic core having low iron loss and a high magnetic permeability can be obtained.

Hereinafter, the composition of the soft magnetic particle 1 will be described in detail.

### Fe

Fe has a large effect on the basic magnetic properties and mechanical properties of the soft magnetic particle 1. Fe is rich in magnetism and has favorable mechanical properties, and therefore is preferably a main component of the Fe—Al-M-based alloy.

The “main component” is referred to as an element whose content is the highest in mass ratio among the elements constituting the Fe—Al-M-based alloy. The content of Fe in the Fe—Al-M-based alloy is preferably set to 50 mass % or more.

### Al

Al contributes to the enhancement of the magnetic permeability of the soft magnetic particle 1 by forming an alloy or an intermetallic compound along with Fe. Further, Al can increase the volume resistivity of the metal particle 2, and therefore can contribute to the reduction in induced current generated in the soft magnetic particle 1, and thus can achieve a reduction in iron loss of the powder magnetic core.

Further, by adding Al, the adhesion to the surface layer 3 containing alumina as the main material can be enhanced. According to this, peeling or the like is less likely to occur between the metal particle 2 and the surface layer 3, and therefore, a powder magnetic core having high reliability is obtained.

The content of Al is preferably 0.5 mass % or more and 8 mass % or less, more preferably 1 mass % or more and 6 mass % or less, further more preferably 1.5 mass % or more and 5.5 mass % or less. In these ranges, a favorable balance between the improvement of the magnetic permeability and the improvement of the volume resistivity of the soft magnetic particle 1 can be achieved.

When the content of Al is lower than the above lower limit, depending on the composition of the Fe—Al-M-based alloy, it becomes difficult to improve the magnetic permeability of the soft magnetic particle 1, or peeling or the like occurs between the metal particle 2 and the surface layer 3, and therefore, for example, the insulation resistance between the soft magnetic particles 1 may be decreased. On the other hand, when the content of Al exceeds the above upper limit, depending on the composition of the Fe—Al-M-based alloy, Al becomes excessive, and therefore, the magnetic permeability of the soft magnetic particle 1 is decreased, or the mechanical properties such as toughness of the metal particle 2 may be deteriorated.

### M

M represents at least one of Cr and Ti. Therefore, M may be Cr or may be Ti, or may be both Cr and Ti.

By adding Cr into the metal particle 2, alumina is likely to be dominantly present in the surface layer 3. That is, the addition of Cr contributes to the stabilization of the alumina in the surface layer 3. Therefore, the surface layer which contains alumina as a main material, and has a sufficient thickness and a high insulating property can be maintained. As a result, the insulation resistance between the soft magnetic particles 1 is increased, and an induced current between the soft magnetic particles 1 is suppressed, and thus, a powder magnetic core having particularly low iron loss can be realized. Further, the flowability of the soft magnetic particle 1 is increased, so that the moldability becomes favorable, and thus, a powder magnetic core having excellent magnetic properties such as magnetic permeability and saturation magnetic flux density can be realized.

On the other hand, by adding Ti into the metal particle 2, the same effect as the addition of Cr described above is obtained. That is, the addition of Ti contributes to the stabilization of the alumina in the surface layer 3, and can realize a powder magnetic core having particularly low iron loss can be realized.

The content of M is preferably 0.5 mass % or more and 13 mass % or less, more preferably 0.7 mass % or more and 10 mass % or less, further more preferably 0.8 mass % or more and 5 mass % or less. In these ranges, sufficient stabilization of the alumina in the surface layer 3 is achieved.

When the content of M is lower than the above lower limit, depending on the composition of the Fe—Al-M-based alloy, the stabilization of the alumina in the surface layer 3 cannot be achieved, and the insulating property of the surface layer 3 is decreased, or the flowability (moldability) of the soft magnetic particle 1 is decreased, or the deterioration of the magnetic properties due to oxidation of the metal particle 2 may be caused. On the other hand, when the content of M exceeds the above upper limit, depending on the composition of the Fe—Al-M-based alloy, there is a fear that it becomes difficult to improve the magnetic permeability of the soft magnetic particle 1, or an oxide of M becomes dominant in the surface layer 3, and a sufficient insulating property is not obtained, or the mechanical properties such as toughness of the metal particle 2 are deteriorated.

When M is Cr, the content of M refers to the content of Cr, and when M is Ti, the content of M refers to the content of Ti, and when M is Cr and Ti, the content of M refers to the sum of the content of Cr and the content of Ti.

Further, when M is Cr and Ti, the ratio of Cr to Ti is not particularly limited, however, it is preferred that the content of Cr is larger than the content of Ti. With this configuration, the effect such as the stabilization of the alumina in the surface layer 3 becomes more prominent. In this case, the content of Cr is preferably 101 mass % or more and 500 mass % or less, more preferably 150 mass % or more and 400 mass % or less of the content of Ti. In these ranges, the stabilization of the alumina in the surface layer 3 can be achieved while minimizing the effect on the magnetic permeability of the soft magnetic particle 1. In addition thereto, the volume resistivity of the metal particle 2 can be increased, and also an induced current generated in the soft magnetic particle 1 can be reduced.

Further, in the soft magnetic particle 1, the ratio of the content of Al to the content of M is preferably 0.5 or more and 6 or less, more preferably 1 or more and 5 or less, further more preferably 1.2 or more and 4.5 or less in mass ratio. By setting the ratio of the content of Al to the content of M within the above ranges, a favorable balance between the action of the Al and the action of the M can be achieved. That is, the adhesion between the metal particle 2 and the surface layer 3 and the stabilization of the alumina in the surface layer 3 can be achieved at the same time.

Summarizing the above, it is preferred that the soft magnetic particle 1 contains Fe as the main component, contains Al at 0.5 mass % or more and 8 mass % or less, and contains M at 0.5 mass % or more and 13 mass % or less. According to this configuration, the soft magnetic particle 1 is rich in magnetism and has favorable mechanical properties. Further, a favorable balance between the improvement of the magnetic permeability and the improvement of the volume resistivity of the soft magnetic particle 1 can be achieved. Further, sufficient stabilization of the alumina in the surface layer 3 is achieved.

### Other Elements

The soft magnetic particle 1 may contain other elements in addition to those described above.

Examples of such other elements include P (phosphorus), S (sulfur), Si (silicon), and Mn (manganese). These elements, for example, increase the hardness of the metal particle 2. Due to this configuration, the soft magnetic particle 1 is hardly deformed when powder compaction molding is performed, and therefore, damage or the like of the surface layer 3 is less likely to occur.

Further, these elements contribute to the lowering of the melting point of the Fe—Al-M-based alloy. Due to this, when the starting material of the Fe—Al-M-based alloy is melted, the viscosity of the molten metal can be decreased, and for example, when the soft magnetic particle 1 is produced by a powdering method such as an atomization method, the soft magnetic particles 1 can be efficiently produced in which particles having an irregular shape are few, and which have a uniform particle diameter. Also from such a viewpoint, the soft magnetic particle 1 is obtained in which damage or the like of the surface layer 3 is less likely to occur.

The content of each of P and S is set to preferably about 0.01 mass % or more and 0.5 mass % or less, more preferably about 0.05 mass % or more and 0.3 mass % or less. In these ranges, the hardness can be increased while avoiding an increase in the brittleness of the soft magnetic particle 1. Further, the melting point of the Fe—Al-M-based alloy can be sufficiently decreased without deteriorating the magnetic properties of the soft magnetic particle 1, and the soft magnetic particles 1 are easily produced in which particles having an irregular shape are few, and which have a uniform particle diameter.

The content of Si is set to preferably about 0.1 mass % or more and 2 mass % or less, more preferably about 0.3 mass % or more and 1.5 mass % or less. In these ranges, the magnetic permeability of the soft magnetic particle 1 can be further enhanced.

The content of Mn is set to preferably about 0.1 mass % or more and 2 mass % or less, more preferably about 0.3 mass % or more and 1.5 mass % or less. In these ranges, the hardness of the soft magnetic particle 1 can be further increased. Further, in a case where S is contained in a relatively large amount, the high temperature brittleness of the soft magnetic particle 1 may increase in some cases. However, by including Mn in a proportion within the above ranges, MnS (manganese sulfide) is generated, and the high temperature brittleness can be suppressed. Therefore, by using S and Mn in combination, destruction or deficit of the soft magnetic particle 1 is less likely to occur, and thus, the soft magnetic particle 1 which is particularly stable over a long period of time is obtained.

The oxygen content of the soft magnetic particle 1 is preferably 100 ppm or more and 10000 ppm or less, more preferably 500 ppm or more and 8500 ppm or less, further more preferably 1000 ppm or more and 6000 ppm or less in mass ratio. By causing the oxygen content to fall within the above ranges, the soft magnetic particle 1 can achieve moldability and magnetic permeability at the same time. That is, when the oxygen content is lower than the above lower limit, depending on the particle diameter of the soft magnetic particle 1, the thickness of the surface layer 3 can be insufficient. Due to this, the insulating property between the soft magnetic particles 1 is insufficient, and the iron loss of the powder magnetic core may be increased. On the other hand, when the oxygen content exceeds the above upper limit, depending on the particle diameter of the soft magnetic particle 1, the thickness of the surface layer 3 can be too large. Due to this, the proportion of the metal particles 2 is decreased, and thus, the magnetic properties of the powder magnetic core may be deteriorated.

Further, the soft magnetic particle 1 may contain elements other than the above-mentioned elements as impurities within a range that does not impair the effect of the embodiment described above. The mixed amount of each element as the impurity in the soft magnetic particle 1 is preferably 0.1 mass % or less, more preferably 0.05 mass % or less. Further, the total amount of the impurities is preferably 0.5 mass % or less. When the amount of the impurities is within such a range, the mixing of impurities hardly exerts an adverse effect whether they are mixed inevitably or intentionally.

The composition of the soft magnetic particle 1 can be determined by, for example, Iron and steel—Atomic absorption spectrometric method specified in JIS G 1257 (2000), Iron and steel—ICP atomic emission spectrometric method specified in JIS G 1258 (2007), Iron and steel—Method for spark discharge atomic emission spectrometric analysis specified in JIS G 1253 (2002), Iron and steel—Method for X-ray fluorescence spectrometric analysis specified in JIS G 1256 (1997), gravimetry, titrimetry, and absorption spectroscopy specified in JIS G 1211 to G 1237, or the like. Specifically, for example, an optical emission spectrometer for solids (a spark emission spectrometer, model: Spectrolab, type: LAVMB08A) manufactured by SPECTRO Analytical Instruments GmbH or an ICP device (model: CIROS-120) manufactured by Rigaku Corporation can be used.

Further, when C (carbon) and S (sulfur) are determined, particularly, an infrared absorption method after combustion in a stream of oxygen (after combustion in a high-frequency induction heating furnace) specified in JIS G 1211 (2011) can be used. Specifically, a carbon-sulfur analyzer, CS-200 manufactured by LECO Corporation can be used.

Further, when N (nitrogen) and O (oxygen) are determined, particularly, Iron and steel—Method for determination of nitrogen content specified in JIS G 1228 (2006) and Method for determination of oxygen content in metallic materials specified in JIS Z 2613 (2006) can be used. Specifically, an oxygen/nitrogen analyzer TC-300/EF-300 manufactured by LECO Corporation or an oxygen/nitrogen/hydrogen analyzer ONH-836 manufactured by LECO Corporation can be used. The amount of a sample is preferably set to 0.1 g.

### Metal Particle

Next, the metal particle 2 will be described.

The metal particle 2 is located on the inner side of the surface layer 3 in the soft magnetic particle 1, and has a dominant effect on the mechanical properties and magnetic properties of the soft magnetic particle 1.

The metal particle 2 contains the above-mentioned Fe—Al-M-based alloy, and is produced from a starting material through a powdering method. Examples of the powdering method include an atomization method and a pulverization method.

The metal particle 2 produced by an atomization method among these is preferably used. The atomization method is a method in which a molten metal is caused to collide with a cooling medium (such as a liquid or a gas) and formed into a powder. The molten metal is formed into a fine liquid droplet by spraying the molten metal or causing the molten metal to collide with a cooling medium, and also rapidly cooled and solidified by bringing this liquid droplet into contact with the cooling medium. At this time, the liquid droplet is cooled while freely falling, and therefore, is formed into a spherical shape by its own surface tension. Accordingly, the resulting metal particles have a shape close to a spherical shape and particles having an irregular shape are reduced, and therefore, the metal particles 2 having a uniform particle diameter are obtained.

Examples of the atomization method include a water atomization method, a spinning water atomization method, a gas atomization method, a vacuum melting gas atomization method, a gas-water atomization method, and an ultrasonic atomization method.

Among these, as the atomization method, a water atomization method or a spinning water atomization method is preferably used. According to such an atomization method, a medium having a large specific gravity (for example, water or the like) is used as the cooling medium, and therefore, the molten metal can be more finely divided. Accordingly, the metal particles 2 having a more uniform particle diameter are obtained.

### Surface Layer

Next, the surface layer 3 will be described.

The surface layer 3 is provided on the surface of the metal particle 2 in the soft magnetic particle 1.

The surface layer 3 is a coating film containing alumina as a main material. The surface layer 3 may be located on at least a portion of the surface of the metal particle 2, and may not necessarily cover the entire surface of the metal particle 2. However, entire encapsulation of the metal particle 2 by the surface layer 3 is preferred.

The alumina is not limited other than being aluminum oxide, and examples thereof include Al₂O₃, AlO₂, and AlO, and it can be one type or a mixture of two or more types among these.

The surface layer 3 may contain an oxide other than alumina. Examples of such an oxide include iron oxide, chromium oxide, and titanium oxide, and it can be one type or a mixture of two or more types among these. Examples of the iron oxide among these include Fe₃O₄, Fe₂O₃, and FeO, and it can be one type or a mixture of two or more types among these.

Alumina in the surface layer 3 is a main material, that is, a component whose content is the highest. The content of alumina in the surface layer 3 is preferably 40 mass % or more, more preferably 50 mass % or more and 99 mass % or less, further more preferably 70 mass % or more and 95 mass % or less. In these ranges, a high insulating property derived from the alumina is imparted to the surface layer 3. Therefore, an induced current flowing between the soft magnetic particles 1 can be suppressed. Further, an insulating property can be ensured even if the surface layer 3 is made thin, or at a high temperature, and thus, the magnetic properties of a powder magnetic core can be enhanced.

Further, by providing the surface layer 3, when an insulating film containing a glass material or the like is formed on the surface of the soft magnetic particle 1, the adhesion between the insulating film and the soft magnetic particle 1 can be further enhanced. According to this configuration, a powder magnetic core having an excellent insulating property between particles is obtained.

Further, the surface layer 3 preferably contains an oxide of M, that is, at least one of chromium oxide and titanium oxide at a content amount lower than that of alumina. According to this configuration, the stabilization of the alumina in the surface layer 3 can be achieved by the addition of chromium oxide or titanium oxide while sufficiently ensuring the insulating property derived mainly from alumina.

The phrase “an oxide of M at a content amount lower than that of alumina” means that the sum of the content of chromium oxide and the content of titanium oxide is lower than the content of alumina in mass ratio.

The content of the oxide of M in the surface layer 3 is preferably 0.1 mass % or more and 40 mass % or less, more preferably 1 mass % or more and 30 mass % or less of the content of alumina. In these ranges, a balance between a high insulating property derived from the alumina and the stabilization of the alumina by the oxide of M is achieved, and thus, the soft magnetic particle 1 having a favorable insulating property over a long period of time is obtained. Further, such a soft magnetic particle 1 is also heat resistant.

When the content of the oxide of M is lower than the above lower limit, depending on the composition of the surface layer 3, the stabilization of the alumina in the surface layer 3 is decreased, and, for example, the insulating property of the surface layer 3 may be deteriorated when it is heated at a high temperature. On the other hand, when the content of the oxide of M exceeds the above upper limit, the content of alumina is relatively decreased, and therefore, depending on the composition of the surface layer 3, the insulating property of the surface layer 3 may be deteriorated.

The content of alumina, chromium oxide, titanium oxide, and iron oxide in such a surface layer 3 can be determined by, for example, applying secondary ion mass spectrometry to the surface layer 3. At this time, in the calculation of the content of the oxide, the calculation may be performed by hypothetically assuming that the total amount of Al becomes Al₂O₃, the total amount of Cr becomes Cr₂O₃, the total amount of Ti becomes TiO₂, and the total amount of Fe becomes Fe₃O₄. Further, depending on the size of the soft magnetic particle 1, the cross section of the surface layer 3 is observed, and the mass content may be calculated based on the area ratio by elemental mapping.

The thickness of the surface layer 3 is not particularly limited, but is preferably 1 nm or more and 3 μm or less, more preferably 3 nm or more and 1 μm or less, further more preferably 5 nm or more and 500 nm or less. When the thickness of the surface layer 3 is within the above ranges, the soft magnetic particle 1 can achieve moldability and magnetic permeability at the same time.

The thickness of the surface layer 3 can be determined by, for example, calculation based on a time required for removing the surface layer 3 by ion sputtering or the like.

Properties of Soft Magnetic Powder

The average particle diameter of the soft magnetic powder as described above is preferably 1 μm or more and 40 μm or less, more preferably 3 μm or more and 30 μm or less. By using the soft magnetic powder having such average particle diameters, a path through which an eddy current flows can be shortened, and therefore, a powder magnetic core which can sufficiently suppress eddy current loss generated in the soft magnetic powder can be produced. Further, since the average particle diameter is moderately small, the filling properties can be enhanced when the powder is compacted. As a result, the filling density of a powder magnetic core can be increased, and thus, the saturation magnetic flux density and the magnetic permeability of the powder magnetic core can be increased.

When the average particle diameter of the soft magnetic powder is less than the above lower limit, the soft magnetic powder is too fine, and therefore, the filling properties of the soft magnetic powder may be deteriorated. Due to this, the molding density of the powder magnetic core (one example of the green compact) is decreased, and thus, the saturation magnetic flux density or the magnetic permeability of the powder magnetic core may be decreased depending on the composition of the material of the soft magnetic powder or the mechanical properties thereof. On the other hand, when the average particle diameter of the soft magnetic powder exceeds the above upper limit, the eddy current loss generated in the particles of the soft magnetic powder cannot be sufficiently suppressed depending on the composition of the material of the soft magnetic powder or the mechanical properties thereof, and therefore, the iron loss of the powder magnetic core may be increased.

The average particle diameter of the soft magnetic powder is obtained as a particle diameter when the cumulative frequency from the small diameter side reaches 50% in a particle size distribution on a mass basis obtained by laser diffractometry.

The coercive force of the soft magnetic powder is not particularly limited, but is preferably 1 Oe or more and 30 Oe or less (79.6 A/m or more and 2387 A/m or less), more preferably 1 Oe or more and 20 Oe or less (79.6 A/m or more and 1592 A/m or less). By using the soft magnetic powder having such a low coercive force, a powder magnetic core capable of sufficiently suppressing the hysteresis loss even at a high frequency can be produced.

The coercive force of the soft magnetic powder can be measured using a magnetometer (for example, “TM-VSM 1230-MHHL”, manufactured by Tamakawa Co., Ltd., or the like).

The insulation resistance value of the soft magnetic powder when it is formed into a green compact with a predetermined size (the insulation resistance value in a compacted state) is preferably 1 MΩ or more, more preferably 5 MΩ or more, further more preferably 10 MΩ or more. Such an insulation resistance value is achieved without using an insulating material, and therefore is based on the insulating property between the particles of the soft magnetic powder. Therefore, by using the soft magnetic powder which achieves such an insulation resistance value, particles of the soft magnetic powder are sufficiently insulated from each other, so that the amount of insulating material used can be reduced, and thus, the proportion of the soft magnetic powder in a powder magnetic core or the like can be increased by that amount and maximized. As a result, a powder magnetic core which excellently achieves both high magnetic properties and low loss at the same time can be realized.

That is, from the viewpoint of achievement of low loss, a higher insulation resistance value is preferred. However, when considering that the insulation resistance value depends on the thickness of the surface layer 3, an upper limit value of 10000 MΩ or less may be set. According to this configuration, while sufficiently achieving low loss, a desired value for the magnetic properties of the powder magnetic core can be ensured.

The insulation resistance value described above is a value measured as follows.

First, 1 g of the soft magnetic powder to be measured is filled in an alumina cylinder. Then, brass electrodes are disposed on the upper and lower sides of the cylinder.

Then, an electrical resistance between the upper and lower electrodes is measured using a digital multimeter while applying a pressure at a load of 20 kg between the upper and lower electrodes using a digital force gauge.

### Method for Producing Soft Magnetic Powder

Next, a method for producing the soft magnetic powder according to the invention will be described.

First, a metal powder produced by a method as described above is prepared.

Subsequently, the metal powder is subjected to a heat treatment.

The temperature of the heat treatment is not particularly limited, but is preferably 500° C. or higher and 1300° C. or lower, more preferably 600° C. or higher and 1200° C. or lower, further more preferably 700° C. or higher and 1100° C. or lower. Further, as the heat treatment time, a time to maintain the temperature is set to preferably 30 minutes or more and 20 hours or less, more preferably 1 hour or more and 10 hours or less, further more preferably 2 hours or more and 6 hours or less.

The atmosphere of the heat treatment is not particularly limited, but is preferably an inert gas atmosphere such as nitrogen or argon, a reducing gas atmosphere such as hydrogen or an ammonia decomposition gas, or a reduced pressure atmosphere.

By performing the heat treatment under such conditions, the surface layer 3 can be formed on the surface of the particle of the metal powder. Further, by heating under a predetermined temperature condition and also in a non-oxidizing atmosphere, M effectively acts, so that the surface layer 3 is occupied by alumina. That is, by the action of M or the oxide of M, a phenomenon in which iron oxide having been present in the metal powder is converted into alumina (aluminum oxide) occurs. According to this, the soft magnetic particle 1 having an excellent insulating property can be efficiently produced without largely increasing the oxygen content as a whole.

Further, as a result of performing such a heat treatment, the soft magnetic powder has excellent flowability.

Specifically, with respect to the soft magnetic powder according to this embodiment, when the flow rate (sec) is measured according to the flowability testing method for metallic powders specified in JIS Z 2502:2012, the flow rate is preferably 12 seconds or more and 25 seconds or less, more preferably 15 seconds or more and 23 seconds or less. The soft magnetic powder having such flowability shows a favorable filling property when it is molded. Due to this flow rate, a powder magnetic core in which the filling ratio of the soft magnetic powder is high is obtained. Since the filling ratio of the soft magnetic powder is high, such a powder magnetic core has excellent magnetic properties derived from the soft magnetic powder.

The thus obtained soft magnetic powder may be classified as desired. Examples of the classification method include dry classification such as sieve classification, inertial classification, centrifugal classification, and wind power classification, and wet classification such as sedimentation classification.

When the specific surface area of the soft magnetic powder according to this embodiment is measured by the BET method, the specific surface area is preferably 0.32 m²/g or more and 0.58 m²/g or less, more preferably 0.40 m²/g or more and 0.52 m²/g or less. When the soft magnetic powder having such a specific surface area is molded, a favorable filling property is exhibited. As such, a powder magnetic core in which the filling ratio of the soft magnetic powder is high is obtained. Since the filling ratio of the soft magnetic powder is high, such a powder magnetic core has excellent magnetic properties derived from the soft magnetic powder.

The measurement of the specific surface area by the BET method is performed using a BET specific surface area measurement device HM1201-010 manufactured by Mountech Co., Ltd. The amount of a sample is set to 5 g.

### Powder Magnetic Core and Magnetic Element

Next, the powder magnetic core according to this embodiment and the magnetic element according to this embodiment will be described.

The magnetic element according to this embodiment can be applied to a variety of magnetic elements including a magnetic core such as a choke coil, an inductor, a noise filter, a reactor, a transformer, a motor, an actuator, a solenoid valve, and an electrical generator. Further, the powder magnetic core according to this embodiment can be applied to a magnetic core included in these magnetic elements.

Hereinafter, two types of choke coils will be described as representative examples of the magnetic element.

### First Embodiment

First, a choke coil to which a first embodiment of the magnetic element according to the invention is applied will be described.

FIG. 2 is a schematic view (plan view) showing a choke coil to which the first embodiment of the magnetic element according to the invention is applied.

A choke coil 10 shown in FIG. 2 includes a powder magnetic core 11 having a ring shape (toroidal shape) and a conductive wire 12 wound around the powder magnetic core 11. Such a choke coil 10 is generally referred to as “toroidal coil”.

The powder magnetic core 11 is obtained by mixing the soft magnetic powder according to the above-mentioned embodiment, a binding material (binder), and an organic solvent, supplying the obtained mixture in a shaping mold, and press-molding the mixture. That is, the powder magnetic core contains the soft magnetic powder according to the above-mentioned embodiment. Therefore, the powder magnetic core has a high filling ratio, and thus, the powder magnetic core 11 having a high insulating property between particles derived from the soft magnetic powder and a high magnetic permeability derived from the high filling property is obtained.

Further, as described above, the choke coil 10 which is one example of the magnetic element includes the powder magnetic core 11. Therefore, the choke coil 10 has a high magnetic permeability, low iron loss, and high reliability. As a result, when the choke coil 10 is mounted on an electronic device or the like, the choke coil 10 contributes to the improvement of the reliability and performance of the electronic device or the like.

If desired, an insulating film may be formed on the surface of each particle of the soft magnetic powder. Examples of the constituent material of this insulating film include inorganic materials such as phosphates such as magnesium phosphate, calcium phosphate, zinc phosphate, manganese phosphate, and cadmium phosphate, and silicates (liquid glass) such as sodium silicate. Further, it may be a material appropriately selected from the organic materials exemplified as the constituent material of the binding material described below.

On the other hand, when the insulating property of the soft magnetic powder (surface layer 3) is high, the insulating property between particles is easily ensured even if the formation of such an insulating film is omitted. Therefore, the filling ratio of the soft magnetic powder in the powder magnetic core is increased by such an amount that the insulating film is omitted, and thus, a powder magnetic core having more excellent magnetic properties is obtained.

Examples of the constituent material of the binding material to be used for producing the powder magnetic core 11 include organic materials such as a silicone-based resin, an epoxy-based resin, a phenolic resin, a polyamide-based resin, a polyimide-based resin, and a polyphenylene sulfide-based resin, and inorganic materials such as phosphates such as magnesium phosphate, calcium phosphate, zinc phosphate, manganese phosphate, and cadmium phosphate, and silicates (liquid glass) such as sodium silicate, and particularly, a thermosetting polyimide-based resin or a thermosetting epoxy-based resin is preferred. These resin materials are easily cured by heating and also have excellent heat resistance. Therefore, the ease of production of the powder magnetic core 11 and the heat resistance thereof can be increased.

The ratio of the binding material to the soft magnetic powder slightly varies depending on the desired saturation magnetic flux density and mechanical properties, the allowable eddy current loss, etc. of the powder magnetic core 11 to be produced, but is preferably about 0.5 mass % or more and 5 mass % or less, more preferably about 1 mass % or more and 3 mass % or less. In these ranges, the powder magnetic core 11 having excellent magnetic properties such as saturation magnetic flux density and magnetic permeability can be obtained while sufficiently binding the particles of the soft magnetic powder.

The organic solvent is not particularly limited as long as it can dissolve the binding material, but examples thereof include various solvents such as toluene, isopropyl alcohol, acetone, methyl ethyl ketone, chloroform, and ethyl acetate.

Any of a variety of additives may be added to the above-mentioned mixture for an arbitrary purpose as desired.

Examples of the constituent material of the conductive wire 12 include materials having high electrical conductivity, for example, metal materials including Cu, Al, Ag, Au, Ni, and the like.

On the surface of the conductive wire 12, a surface layer having an insulating property may be provided. According to this configuration, a short circuit between the powder magnetic core 11 and the conductive wire 12 can be more reliably prevented. Examples of the constituent material of such a surface layer include various resin materials.

The shape of the powder magnetic core 11 is not limited to the ring shape shown in FIG. 2, and may be, for example, a shape of a ring which is partially missing (a split ring) or may be a rod shape.

Further, the powder magnetic core 11 may contain a soft magnetic powder other than the soft magnetic powder according to the above-mentioned embodiment as desired.

### Second Embodiment

Next, a choke coil to which a second embodiment of the magnetic element according to the invention is applied will be described.

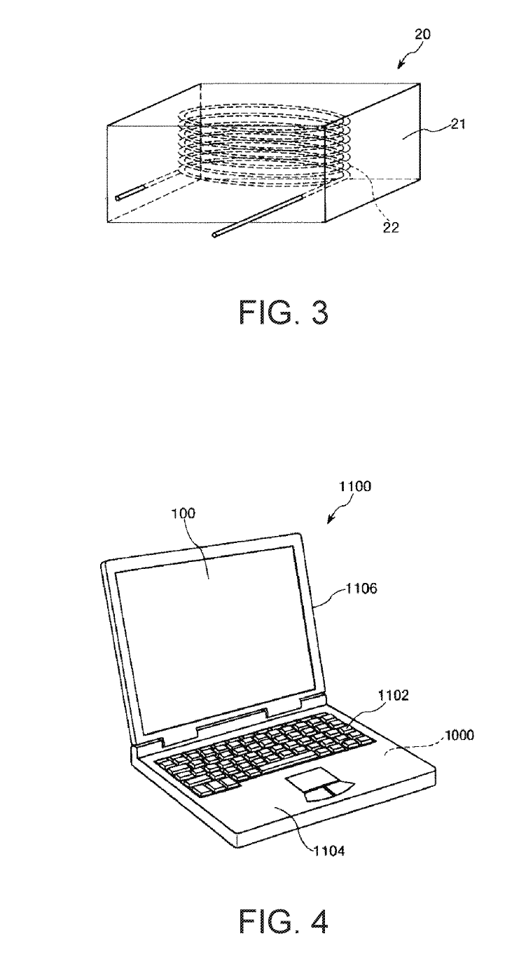

FIG. 3 is a schematic view (transparent perspective view) showing a choke coil to which a second embodiment of the magnetic element according to the invention is applied.

Hereinafter, the choke coil according to the second embodiment will be described, however, in the following description, different points from the above-mentioned choke coil according to the first embodiment will be mainly described and the description of the same matter will be omitted.

As shown in FIG. 3, a choke coil 20 according to this embodiment is configured such that a conductive wire 22 molded into a coil shape is embedded inside a powder magnetic core 21. That is, the choke coil 20 is obtained by molding the conductive wire 22 with the powder magnetic core 21.

As the choke coil 20 having such a configuration, a relatively small choke coil is easily obtained. In a case where such a small choke coil 20 is produced, by using the powder magnetic core 21 having a high saturation magnetic flux density and a high magnetic permeability, and also having low loss, the choke coil 20 which has low loss and generates low heat so as to be able to cope with a large current although the size is small is obtained.

Further, since the conductive wire 22 is embedded inside the powder magnetic core 21, virtually no gap is generated between the conductive wire 22 and the powder magnetic core 21. According to this configuration, vibration of the powder magnetic core 21 due to magnetostriction is suppressed, and thus, it is also possible to suppress the generation of noise accompanying this vibration.

Further, the powder magnetic core 21 may contain a soft magnetic powder other than the soft magnetic powder according to the above-mentioned embodiment as desired.

### Electronic Device

Next, an electronic device (the electronic device according to this embodiment) including the magnetic element according to the above-mentioned embodiment will be described in detail with reference to FIGS. 4 to 6.

FIG. 4 is a perspective view showing a structure of a mobile-type (or notebook-type) personal computer, to which an electronic device including the magnetic element according to the embodiment is applied. In this drawing, a personal computer 1100 includes a main body 1104 provided with a key board 1102, and a display unit 1106 provided with a display section 100. The display unit 1106 is supported rotatably with respect to the main body 1104 via a hinge structure. Such a personal computer 1100 includes a built-in magnetic element 1000, for example, a choke coil, an inductor, a motor for a switching power supply, or the like.

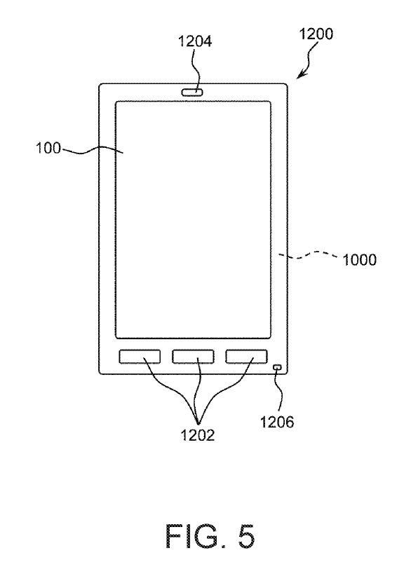

FIG. 5 is a plan view showing a structure of a smartphone, to which an electronic device including the magnetic element according to the embodiment is applied. In this drawing, a smartphone 1200 includes a plurality of operation buttons 1202, an earpiece 1204, and a mouthpiece 1206, and between the operation buttons 1202 and the earpiece 1204, a display section 100 is placed. Such a smartphone 1200 includes a built-in magnetic element 1000, for example, an inductor, a noise filter, a motor, or the like.

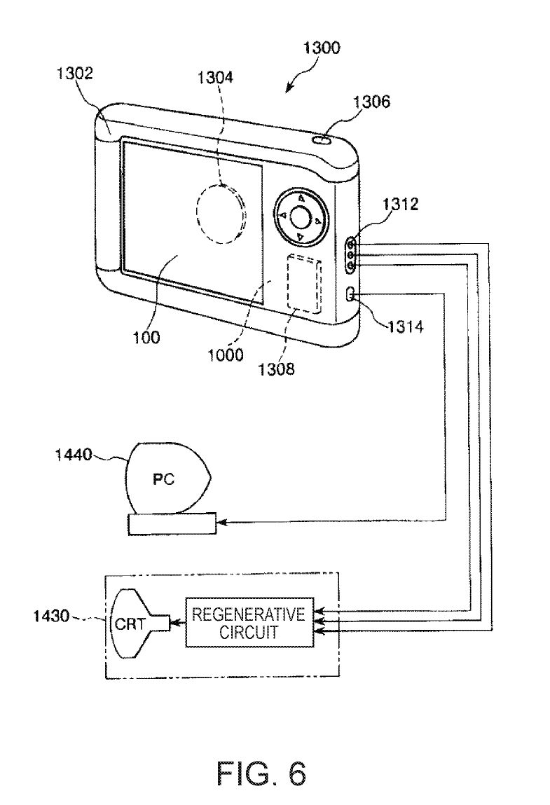

FIG. 6 is a perspective view showing a structure of a digital still camera, to which an electronic device including the magnetic element according to the embodiment is applied. In this drawing, connection to external devices is also briefly shown. A digital still camera 1300 generates an imaging signal (image signal) by photoelectrically converting an optical image of a subject into the imaging signal by an imaging device such as a CCD (Charge Coupled Device).

On a back surface of a case (body) 1302 in the digital still camera 1300, a display section 100 is provided, and the display section 100 is configured to display an image taken on the basis of the imaging signal by the CCD. The display section 100 functions as a finder which displays a subject as an electronic image. Further, on a front surface side (on a back surface side in the drawing) of the case 1302, a light receiving unit 1304 including an optical lens (an imaging optical system), a CCD, or the like is provided.

When a person who takes an image confirms the image of a subject displayed on the display section 100 and pushes a shutter button 1306, an imaging signal of the CCD at that time is transferred to a memory 1308 and stored there. Further, a video signal output terminal 1312 and an input/output terminal 1314 for data communication are provided on a side surface of the case 1302 in this digital still camera 1300. As shown in the drawing, a television monitor 1430 is connected to the video signal output terminal 1312 and a personal computer 1440 is connected to the input/output terminal 1314 for data communication as desired. Moreover, the digital still camera 1300 is configured such that the imaging signal stored in the memory 1308 is output to the television monitor 1430 or the personal computer 1440 by a predetermined operation. Also such a digital still camera 1300 includes a built-in magnetic element 1000, for example, an inductor, a noise filter, or the like.

Incidentally, the electronic device including the magnetic element according to the embodiment can be applied to, other than the personal computer (mobile-type personal computer) shown in FIG. 4, the smartphone shown in FIG. 5, and the digital still camera shown in FIG. 6, for example, a cellular phone, a tablet terminal, a timepiece, an inkjet-type ejection device (such as an inkjet printer), a laptop-type personal computer, a television, a video camera, a videotape recorder, a car navigation device, a pager, an electronic organizer (also including an electronic organizer having a communication function), an electronic dictionary, an electronic calculator, an electronic gaming machine, a word processor, a workstation, a videophone, a security television monitor, electronic binoculars, a POS terminal, medical devices (such as an electronic thermometer, a blood pressure meter, a blood sugar meter, an electrocardiogram monitoring device, an ultrasound diagnostic device, and an electronic endoscope), a fish finder, various measurement devices, meters and gauges (such as meters and gauges for vehicles, airplanes, and ships), a moving object controlling device (such as a controlling device for a driving vehicle), a flight simulator, and the like.

As described above, such an electronic device includes the magnetic element according to the embodiment. Therefore, an electronic device, which achieves high performance and low power consumption and has high reliability can be realized.

Hereinabove, the soft magnetic powder, the powder magnetic core, the magnetic element, and the electronic device according to the invention have been described based on the preferred embodiments. However, the invention is not limited thereto.

For example, in the above-mentioned embodiments, as the application example of the soft magnetic powder according to the invention, the powder magnetic core is described, however, the application example is not limited thereto, and for example, it may be applied to a magnetic fluid, a magnetic shielding sheet, or a magnetic element such as a magnetic head.

Further, the shapes of the powder magnetic core and the magnetic element are not limited to those shown in the drawings, and may be any shapes.

### EXAMPLES

Next, specific examples of the invention will be described.

### 1. Production of Soft Magnetic Powder

### Sample No. 1

First, an Fe—Al—Cr-based alloy powder produced by an atomization method was prepared. The composition of the alloy powder is as shown in Table 1.

Subsequently, the prepared alloy powder was subjected to a heat treatment. By doing this, a soft magnetic powder was obtained. The conditions for the heat treatment are as shown in Table 1.

### Sample Nos. 2 to 33

Soft magnetic powders were obtained in the same manner as the sample No. 1 except that the composition of the alloy powder and the conditions for the heat treatment were changed as shown in Tables 1 and 2.

In Tables 1 and 2, the soft magnetic powders of sample Nos. corresponding to the invention are denoted by “Ex.” (Example), and the soft magnetic powders of sample Nos. not corresponding to the invention are denoted by “Com. Ex.” (Comparative Example).

The average particle diameter of the soft magnetic powders of the respective sample Nos. was 5 μm or more and 25 μm or less.

### 2. Evaluation of Soft Magnetic Powder

### 2.1. Specification of Main Material of Surface Layer

With respect to each of the soft magnetic powders of the respective sample Nos., the main material of the surface layer was specified. In this specification, alumina, chromium oxide, titanium oxide, and iron oxide were quantitatively determined using secondary ion mass spectrometry, and an oxide whose mass content is the highest was determined.

The results of the specification are shown in Tables 1 and 2.

### 2.2. Measurement of Oxygen Content and Nitrogen Content

With respect to each of the soft magnetic powders of the respective sample Nos., the oxygen content and the nitrogen content were measured.

The measurement results are shown in Tables 1 and 2.

### 2.3. Measurement of Insulation Resistance Value

With respect to each of the soft magnetic powders of the respective sample Nos., the insulation resistance value was measured.

The measurement results are shown in Tables 1 and 2.

### 2.4. Measurement of Magnetic Permeability

With respect to each of the soft magnetic powders of the respective sample Nos., the magnetic permeability (relative magnetic permeability) was measured under the following measurement conditions. The magnetic permeability as used herein refers to a relative magnetic permeability (effective magnetic permeability) determined from the self-inductance of a closed magnetic circuit magnetic core coil.

Measurement Conditions for Magnetic Permeability (Relative Magnetic Permeability)
Measurement device: impedance analyzer (HEWLETT PACKARD 4194A)
Measurement frequency: 100 kHz
Number of turns of coil wire: 7
Diameter of coil wire: 0.8 mm

The measurement results are shown in Tables 1 and 2.

### 2.5. Measurement of Specific Surface Area

With respect to each of the soft magnetic powders of the respective sample Nos., a BET specific surface area was measured.

The measurement results are shown in Tables 1 and 2.

### 2.6. Measurement of Flowability

With respect to each of the soft magnetic powders of the respective sample Nos., a flow rate (sec) was measured according to the flowability testing method for metallic powders specified in JIS Z 2502:2012.

The measurement results are shown in Tables 1 and 2.

TABLE 1

| | | | | | | | | | | | | Evaluation results of soft magnetic powder | | | | | | |
|---|---|---|---|---|---|---|---|---|---|---|---|---|---|---|---|---|---|---|
| | | | | | | | | | | | | Main | | | | | | |
| | | Production conditions for soft magnetic powder | | | | | | | | | | material | | | | | | |
| | | Alloy composition | | | | | | | Heat treatment | | | of | | | Insulation | | Specific | |
| | | | M | | | | | | Heating | Heating | | surface | Oxygen | Nitrogen | resistance | Magnetic | surface | Flow |
| | | Al | Cr | Ti | Si | Mn | Fe | Al/M | temperature | time | Atmosphere | layer | content | content | value | permeability | area | rate |
| | | mass % | mass % | mass % | mass % | mass % | — | — | ° C. | hour | — | — | ppm | ppm | MΩ | — | m²/g | sec |
| No. | Example | 4.0 | 1.0 | | 0.3 | 0.1 | bal. | 4.0 | 800 | 4 | H₂ | alumina | 5100 | 91 | 24 | 34.6 | 0.421 | 18.2 |
| 1 | | | | | | | | | | | | | | | | | | |
| No. | Example | 4.0 | 1.0 | | 0.3 | 0.1 | bal. | 4.0 | 800 | 4 | Ar | alumina | 5300 | 82 | 13 | 34.1 | 0.462 | 18.5 |
| 2 | | | | | | | | | | | | | | | | | | |
| No. | Example | 4.0 | 1.0 | | 0.3 | 0.1 | bal. | 4.0 | 800 | 4 | N₂ | alumina | 5400 | 3300 | 1097 | 29.7 | 0.499 | 20.6 |
| 3 | | | | | | | | | | | | | | | | | | |
| No. | Example | 4.2 | | 0.8 | 0.4 | 0.2 | bal. | 5.3 | 800 | 4 | H₂ | alumina | 6400 | 95 | 24 | 33.7 | 0.430 | 18.7 |
| 4 | | | | | | | | | | | | | | | | | | |
| No. | Example | 4.2 | | 0.8 | 0.4 | 0.2 | bal. | 5.3 | 800 | 4 | Ar | alumina | 6600 | 85 | 13 | 33.2 | 0.475 | 19.0 |
| 5 | | | | | | | | | | | | | | | | | | |
| No. | Example | 4.2 | | 0.8 | 0.4 | 0.2 | bal. | 5.3 | 800 | 4 | N₂ | alumina | 6700 | 4000 | 1069 | 29.0 | 0.482 | 20.1 |
| 6 | | | | | | | | | | | | | | | | | | |
| No. | Example | 3.8 | 0.6 | 0.6 | 0.5 | 0.0 | bal. | 3.2 | 800 | 4 | H₂ | alumina | 5800 | 100 | 25 | 35.5 | 0.409 | 17.8 |
| 7 | | | | | | | | | | | | | | | | | | |
| No. | Example | 3.8 | 0.6 | 0.6 | 0.5 | 0.0 | bal. | 3.2 | 800 | 4 | Ar | alumina | 6000 | 94 | 13 | 34.9 | 0.453 | 18.1 |
| 8 | | | | | | | | | | | | | | | | | | |
| No. | Example | 3.8 | 0.6 | 0.6 | 0.5 | 0.0 | bal. | 3.2 | 800 | 4 | N₂ | alumina | 6100 | 2800 | 1122 | 30.7 | 0.461 | 19.2 |
| 9 | | | | | | | | | | | | | | | | | | |
| No. | Example | 4.0 | 1.0 | | 0.3 | 0.1 | bal. | 4.0 | 950 | 4 | H₂ | alumina | 4400 | 70 | 24 | 34.3 | 0.423 | 18.4 |
| 10 | | | | | | | | | | | | | | | | | | |
| No. | Example | 4.0 | 1.0 | | 0.3 | 0.1 | bal. | 4.0 | 950 | 4 | Ar | alumina | 4600 | 65 | 13 | 33.6 | 0.470 | 18.8 |
| 11 | | | | | | | | | | | | | | | | | | |
| No. | Example | 4.0 | 1.0 | | 0.3 | 0.1 | bal. | 4.0 | 950 | 4 | N₂ | alumina | 4800 | 2500 | 1080 | 29.4 | 0.478 | 19.9 |
| 12 | | | | | | | | | | | | | | | | | | |
| No. | Example | 4.0 | 1.0 | | 0.1 | 0.1 | bal. | 4.0 | 800 | 6 | H₂ | alumina | 4900 | 80 | 25 | 35.9 | 0.405 | 17.6 |
| 13 | | | | | | | | | | | | | | | | | | |
| No. | Example | 4.0 | 0.5 | 0.5 | 0.1 | 0.1 | bal. | 4.0 | 950 | 6 | H₂ | alumina | 4300 | 75 | 26 | 36.5 | 0.398 | 17.3 |
| 14 | | | | | | | | | | | | | | | | | | |
| No. | Compar- | 4.0 | | | 0.5 | 0.1 | bal. | — | 800 | 4 | H₂ | iron | 8900 | 150 | <1 | 34.4 | 0.602 | 25.1 |
| 15 | ative | | | | | | | | | | | oxide | | | | | | |
| | Example | | | | | | | | | | | | | | | | | |
| No. | Compar- | | 1.0 | | 0.3 | 0.2 | bal. | 0.0 | 800 | 4 | Ar | iron | 9200 | 120 | <1 | 34.2 | 0.660 | 27.5 |
| 16 | ative | | | | | | | | | | | oxide | | | | | | |
| | Example | | | | | | | | | | | | | | | | | |
| No. | Compar- | | | 1.0 | 0.4 | 0.1 | bal. | 0.0 | 800 | 4 | N₂ | iron | 9300 | 4500 | <1 | 34.1 | 0.634 | 26.4 |
| 17 | ative | | | | | | | | | | | oxide | | | | | | |
| | Example | | | | | | | | | | | | | | | | | |
| No. | Compar- | 4.0 | 1.0 | | 0.3 | 0.1 | bal. | 4.0 | 800 | 4 | air | iron | 11200 | 1250 | <1 | 32.5 | 0.725 | 30.2 |
| 18 | ative | | | | | | | | | | | oxide | | | | | | |
| | Example | | | | | | | | | | | | | | | | | |
| No. | Compar- | 4.0 | 1.0 | | 0.3 | 0.1 | bal. | 4.0 | 950 | 4 | air | iron | 11500 | 2000 | <1 | 32.1 | 0.758 | 31.6 |
| 19 | ative | | | | | | | | | | | oxide | | | | | | |
| | Example | | | | | | | | | | | | | | | | | |
| No. | Compar- | 4.0 | 1.0 | | 0.3 | 0.1 | bal. | 4.0 | — | — | — | — | 5420 | 80 | <1 | 34.6 | 0.590 | 25.6 |
| 20 | ative | | | | | | | | | | | | | | | | | |
| | Example | | | | | | | | | | | | | | | | | |

TABLE 2

| | | Production conditions for soft magnetic powder | | | | | | | | | |
|---|---|---|---|---|---|---|---|---|---|---|---|
| | | Alloy composition | | | | | | | Heat treatment | | |
| | | | M | | | | | | Heating | Heating | Atmos- |
| | | Al | Cr | Ti | Si | Mn | Fe | Al/M | temperature | time | phere |
| | | mass % | mass % | mass % | mass % | mass % | — | — | ° C. | hour | — |
| No. 21 | Example | 3.0 | 1.0 | | 0.3 | 0.1 | bal. | 3.0 | 800 | 4 | H₂ |
| No. 22 | Example | 3.0 | | 1.0 | 0.3 | 0.1 | bal. | 3.0 | 800 | 4 | Ar |
| No. 23 | Example | 3.0 | 0.5 | 0.5 | 0.3 | 0.1 | bal. | 3.0 | 800 | 4 | N₂ |
| No. 24 | Example | 3.0 | 2.0 | | 0.4 | 0.2 | bal. | 1.5 | 800 | 4 | H₂ |
| No. 25 | Example | 3.0 | | 2.0 | 0.4 | 0.2 | bal. | 1.5 | 800 | 4 | Ar |
| No. 26 | Example | 3.0 | 1.0 | 1.0 | 0.4 | 0.2 | bal. | 1.5 | 800 | 4 | N₂ |
| No. 27 | Example | 3.1 | 2.0 | | 0.2 | 0.1 | bal. | 1.6 | 800 | 5 | H₂ |
| No. 28 | Example | 4.9 | 2.0 | | 0.3 | 0.1 | bal. | 2.5 | 800 | 6 | Ar |
| No. 29 | Example | 5.0 | 4.0 | | 0.3 | 0.1 | bal. | 1.3 | 800 | 6 | N₂ |
| No. 30 | Comparative | 3.0 | 1.0 | | 0.3 | 0.1 | bal. | 3.0 | 800 | 4 | air |
| | Example | | | | | | | | | | |
| No. 31 | Comparative | 3.0 | | 1.0 | 0.3 | 0.1 | bal. | 3.0 | 800 | 4 | air |
| | Example | | | | | | | | | | |
| No. 32 | Comparative | 5.0 | 2.0 | | 0.3 | 0.1 | bal. | 2.5 | 800 | 4 | air |
| | Example | | | | | | | | | | |
| No. 33 | Comparative | 5.0 | 4.0 | | 0.1 | 0.1 | bal. | 1.3 | 800 | 4 | air |
| | Example | | | | | | | | | | |

| | | Evaluation results of soft magnetic powder | | | | | | |
|---|---|---|---|---|---|---|---|---|
| | | Main | | | | | | |
| | | material | Oxy- | Nitro- | Insulation | | Specific | |
| | | of surface | gen | gen | resistance | Magnetic | surface | Flow |
| | | layer | content | content | value | permeability | area | rate |
| | | — | ppm | ppm | MΩ | — | m²/g | sec |
| No. 21 | Example | alumina | 5700 | 100 | 24 | 33.9 | 0.411 | 17.9 |
| No. 22 | Example | alumina | 5900 | 90 | 12 | 32.4 | 0.439 | 17.6 |
| No. 23 | Example | alumina | 5900 | 3500 | 1054 | 28.6 | 0.454 | 18.9 |
| No. 24 | Example | alumina | 5200 | 80 | 23 | 33.1 | 0.421 | 18.3 |
| No. 25 | Example | alumina | 5400 | 75 | 12 | 31.6 | 0.451 | 18.1 |
| No. 26 | Example | alumina | 5900 | 3200 | 1026 | 27.7 | 0.463 | 19.3 |
| No. 27 | Example | alumina | 7100 | 110 | 24 | 34.7 | 0.401 | 17.4 |
| No. 28 | Example | alumina | 7600 | 100 | 13 | 33.1 | 0.430 | 17.2 |
| No. 29 | Example | alumina | 6300 | 3600 | 1077 | 29.3 | 0.444 | 18.5 |
| No. 30 | Comparative | iron oxide | 9200 | 1050 | <1 | 32.1 | 0.653 | 28.4 |
| | Example | | | | | | | |
| No. 31 | Comparative | iron oxide | 10000 | 1100 | <1 | 32.4 | 0.751 | 30.0 |
| | Example | | | | | | | |
| No. 32 | Comparative | iron oxide | 11100 | 950 | <1 | 31.2 | 0.696 | 29.0 |
| | Example | | | | | | | |
| No. 33 | Comparative | iron oxide | 10500 | 850 | <1 | 29.9 | 0.676 | 29.4 |
| | Example | | | | | | | |

As apparent from Tables 1 and 2, it was confirmed that each of the soft magnetic powders of the respective Examples has a high magnetic permeability and also has a high insulation resistance value. It was also confirmed that each of the soft magnetic powders of the respective Examples has high flowability.

From these results, it was revealed that according to the invention, a soft magnetic powder capable of producing a powder magnetic core having a high magnetic permeability and low iron loss when it is compacted is obtained.

The entire disclosure of Japanese Patent Application No. 2017-062969 filed Mar. 28, 2017 is expressly incorporated by reference herein.

What is claimed is:

1. A soft magnetic powder comprising:
a metal particle which contains an Fe—Al-M-based alloy, wherein M is at least one of Cr and Ti; and
a surface layer which is provided on a surface of the metal particle, the surface layer containing alumina as a main material.

2. The soft magnetic powder according to claim 1, wherein the surface layer contains an oxide of the M at a content amount lower than that of alumina.

3. The soft magnetic powder according to claim 1, wherein
the Fe is contained as a main component,
the Al is contained at 0.5 mass % or more and 8 mass % or less, and
the M is contained at 0.5 mass % or more and 13 mass % or less.

4. The soft magnetic powder according to claim 3, wherein a mass ratio of the Al to the M is 0.5 or more and 6 or less.

5. A powder magnetic core comprising:
a soft magnetic powder including:
a metal particle which contains an Fe—Al-M-based alloy, wherein M is at least one of Cr and Ti; and
a surface layer which is provided on a surface of the metal particle, the surface layer containing alumina as a main material;
a binder mixed with the soft magnetic powder; and
an organic solvent mixed with the binder and the soft magnetic powder.

6. The powder magnetic core according to claim 5, wherein the surface layer contains an oxide of the M at a content amount lower than that of alumina.

7. A powder magnetic core according to claim 5, wherein
the Fe is contained as a main component,
the Al is contained at 0.5 mass % or more and 8 mass % or less, and
the M is contained at 0.5 mass % or more and 13 mass % or less.

8. A powder magnetic core according to claim 7, wherein a mass ratio of the Al to the M is 0.5 or more and 6 or less.

9. A magnetic element comprising:
a powder magnetic core including:
a soft magnetic powder including:
a metal particle which contains an Fe—Al-M-based alloy, wherein M is at least one of Cr and Ti; and
a surface layer which is provided on a surface of the metal particle, the surface layer containing alumina as a main material;
a binder mixed with the soft magnetic powder;
an organic solvent mixed with the binder and the soft magnetic powder; and
a conductive wire wound or coiled in operative association with the powder magnetic core.

10. The magnetic element according to claim 9, wherein the surface layer contains an oxide of the M at a content amount lower than that of alumina.

11. The magnetic element according to claim 9, wherein
the Fe is contained as a main component,
the Al is contained at 0.5 mass % or more and 8 mass % or less, and
the M is contained at 0.5 mass % or more and 13 mass % or less.

12. The magnetic element according to claim 11, wherein a mass ratio of the Al to the M is 0.5 or more and 6 or less.
